(19) United States
(12) Patent Application Publication
(10) Pub. No.: US 2013/0152091 A1
(43) Pub. Date: Jun. 13, 2013

(54) Optimized Judge Assignment under Constraints

(71) Applicants: Chao Liu, Redmond, WA (US); Frederick Bruce Shepherd, Medina, WA (US)

(72) Inventors: Chao Liu, Redmond, WA (US); Frederick Bruce Shepherd, Medina, WA (US)

(73) Assignee: MICROSOFT CORPORATION, Redmond, WA (US)

(21) Appl. No.: 13/314,676

(22) Filed: Dec. 8, 2011

(51) Int. Cl. G06F 9/46

(52) U.S. Cl. 718/102

(57) ABSTRACT

Described is a technology by which an assignment model is computed to distribute labeling tasks among judging entities (judges). The assignment model is optimized by obtaining accuracy-related data of the judges, e.g., by probing the judges with labeling tasks having a gold standard label and evaluating the judges' labels against the gold standard labels, and optimizing for accuracy. Optimization may be based upon on or more other constraints, such as per-judge cost and/or quota.

### BACKGROUND

In computer-based technology such as document or other content retrieval, there are many tasks where human labeling of content is needed. For example, image classification, document (including advertisement) categorization, and web search may obtain labels for content with the label values determined by humans. Such labeled content is then used (e.g., as training data) by machine learning algorithms to derive various models.

Human judging to determine what label to give each piece of content is generally imperfect, and thus there are errors in the labeling. Quality of the labels with respect to accurate labeling is thus one consideration when evaluating judgment performance, e.g., of an entity such as a vendor or person hired to perform labeling tasks. In general, labeling tasks are assigned randomly to a judging entity as long as the entity can perform the labeling with reasonable quality. However, from the perspective of the enterprise who is requesting (and typically paying for) the labeling, this is not a particularly advantageous way to assign tasks.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards a technology by which probing tasks are provided to judges (any judging entities) to obtain accuracy-related data with respect to labeling tasks. The accuracy data is used to compute an assignment model for assigning other labeling tasks to at least some of the judges, in which the assignment model distributes the other labeling tasks based at least in part upon the accuracy data. In one aspect, the accuracy-related data may be used to optimize certain business metrics, such as minimizing the expected error rate and/or minimizing the total monetary judging cost.

In one aspect, an assignment engine is configured to provide regular tasks and probing tasks to a plurality of judges for labeling. An optimization mechanism evaluates probed labels corresponding to the probing tasks against gold standard labels to obtain accuracy-related data that is used in optimizing an assignment model. The assignment model is useable to distribute other labeling tasks to at least some of the judges.

In one aspect, upon receiving a task set comprising labeling tasks for assigning to judges, an assignment model distributes the labeling tasks from the task set. The assignment model is optimized at least in part according to per-judge accuracy-related data obtained by probing of the judges.

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 is a block diagram showing example components of a system that computes and/or uses an assignment model to distribute labeling tasks to judges.

FIG. 2 is a flow diagram representing example steps that may be taken to perform an optimization to compute an assignment model based upon a constraint set including accuracy data.

FIG. 3 is a flow diagram representing example steps that may be taken to use the assignment model to distribute labeling tasks to judges.

FIG. 4 is a block diagram representing an example computing environment into which aspects of the subject matter described herein may be incorporated.

### DETAILED DESCRIPTION

Various aspects of the technology described herein are generally directed towards a more optimal way to assign labeling tasks that is based upon labeling quality and other constraints such as cost and/or quota. To this end, for each judge (judging entity) of a set of judges, accuracy of labeling is measured, and combined with labeling costs and possibly one or more other constraints (e.g., quota) to determine a more optimal way (e.g., based upon accuracy and cost) to assign future labeling tasks.

It should be understood that any of the examples herein are non-limiting. For example, obtaining relevance labels for query, URL pairs are used as examples of labeling tasks, however any item or set of items for which labels are desirable may be substituted in such examples. Further, instead of or in addition to humans, labeling tasks may be assigned to machine judges, e.g., configured with artificial intelligence capabilities. As such, the present invention is not limited to any particular embodiments, aspects, concepts, structures, functionalities or examples described herein. Rather, any of the embodiments, aspects, concepts, structures, functionalities or examples described herein are non-limiting, and the present invention may be used in various ways that provide benefits and advantages in computing and task assignment in general.

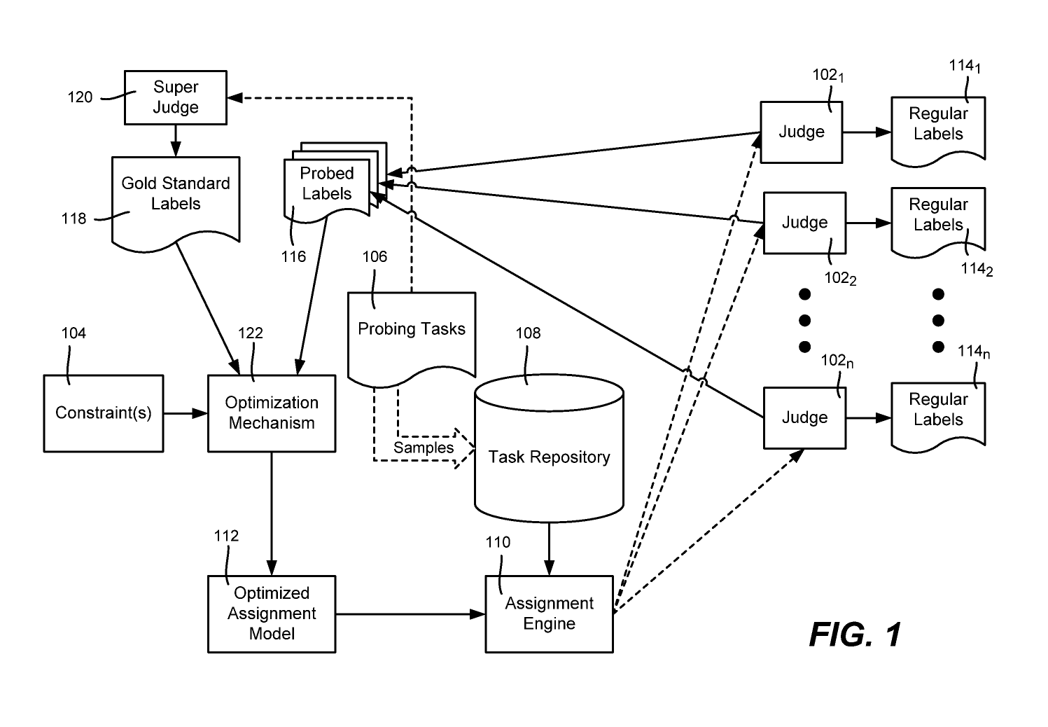

FIG. 1 shows a block diagram comprising an example system for determining how to assign judges 102₁-102ₙ based upon constraints. As used herein, each “judge” is an entity to which tasks may be assigned. In actuality, a judge may be a vendor or the like having one or more individual human judges working for that vendor, such as a team of people. However a “judge” entity may represent as little as a single human, such as in a scenario in which the entities being evaluated as individual humans such as employees. A given judge may also comprise a machine, e.g., configured with artificial intelligence.

Example constraints 104 include cost, comprising the cost for a given judge. Quota, which is basically how many tasks each judge is capable of handling, may be another constraint, e.g., a given vendor may only be able to handle 10,000 tasks per month. Another possible constraint is availability, e.g., a vendor may only be available for a certain time period. Such constraints may be determined contractually with each judge.

In general, the system of FIG. 1 operates to optimize assignment of judges with respect to the constraints 104, which in this example includes cost. To this end, there is provided a process that optimizes the cost effectiveness for general judge-task assignment, while considering quality of the labels. Thus, in one aspect, the many tasks to be handled are divided among the judges by evaluating the work product of the judges in terms of judgment accuracy and cost, while keeping within each judge's quota constraint.

To evaluate the judgment accuracy, probing tasks 106 are used in one implementation, which in general are randomly inserted (e.g., on a sampling basis) into the task repository 108 of tasks assigned by an assignment engine 110 to each judge; judges are not aware whether a task is a probing task or a regular task. Note that an optimized assignment model 112 (as described below) may not yet exist (or may not be chosen to use during probing), and if so a general assignment model, such as a conventional one that assigns tasks among the judges evenly/randomly up to their respective quotas may be used during probing.

In the example of FIG. 1, for each task, the judges assign labels 114₁-114ₙ to each task, such as a score on a scale of one to five labeling the relevance of a document with respect to query text. For the probing tasks 106, probed labels 116 are kept (or extracted from among the regular labels) to determine accuracy of the labeling on a per judge basis.

In one implementation, the accuracy of each judge's probed labels 116 corresponding to the probing tasks 106 is determined by comparing the resultant label for each probing task against a “super judge's” gold standard label 118 for that probing task. A super judge 120 may be an expert, a team of experts, a committee/consensus, and so forth whose scoring opinion is highly trustworthy. The accuracy (which may comprise an error measurement) is recorded for each judge.

Once a sufficient number of probing labels 116 are collected and evaluated for accuracy, the accuracy for a judge is mathematically combined with the cost for that judge in a way that provides the most optimal results with respect to accuracy for the cost, which may also factor in each judge's task handling quota/availability. In general, the more accurate the judge and the lower the cost for that judge, the more tasks that are assigned to that judge, subject to any quota/availability considerations.

As described below, a more optimal assignment of tasks may be determined by solving an optimization (e.g., a minimization) problem. As represented in FIG. 1, an optimization mechanism 122 generates the optimized assignment model 112 that the assignment engine 110 thereafter may use to assign new tasks among the judges 102₁-102ₙ based on the optimization results. In one implementation, the optimization results may be in the form of a probability score/relative assignment weight for each judge (which may correspond to percentages or the like that sum to one). Thus, for example, the judge 102₁ may receive 0.10 of the tasks that are assigned, the judge 102₂ may receive 0.55 of the tasks that are assigned, and so forth among the full set of judges 102₁-102ₙ, such that the tasks are distributed according to the probability score computation for each judge. One or more judges may be dropped by adjusting the model 112, such as if it is deemed not worthwhile in terms of overhead to assign only a few tasks to that judge or judges. Correlation among judges may be evaluated as well, e.g., if for a given type of task, accurate, cost effective results are obtained from using judges A, C and D, then the model may be adjusted to use only those judges.

It should be noted that probing may be ongoing or selectively performed at any time, and for other purposes in addition to optimization. For example, probing may be used for quality control purposes, to ensure that a vendor's accuracy does not change significantly over time. Probing may be used among individual judges for performance evaluation, to identify super judge candidates, and so forth.

Re-optimization may be performed at any time and as often as desired. Non-limiting examples for performing re-optimization include when a new vendor is hired and/or a vendor's quota or price changes, when performance changes are noted among the judges, when new gold standard labels become available, and/or occasionally such as to ensure that a reasonably up-to-date assignment model is in use.

Turning to additional description of one suitable mathematical formulation and efficient solution of optimization, in the following example the system is given a test set of data for query/URL (q,u) judgments, in which each judgment of a pair (q,u) is a label in the form of an integer 1, 2, 3, 4 or 5. For some set of pairs P and set of vendors J, assume that there is a value l(q,u,j) for each (q,u)∈P and j∈J. For each (q,u) there is also the gold standard evaluation G(q,u)∈{1, 2, 3, 4, 5}.

After the evaluation phase, vendors are used to give judgments for (q,u)'s arriving (e.g., online) over some time horizon, where the total number of judgments is approximately M. The operational model works by assigning to vendor j, new query/URL arrivals with some probability pⱼ. In other words, for a given vendor, some percentage of the new query/URL labeling tasks are assigned to that vendor for labeling, in which the percentage is based upon the computed probability pⱼ.

Because in this example the vendor j has a quota sⱼ, these probabilities need to satisfy the constraint pⱼM≦sⱼ. In addition, each vendor has an associated cost cⱼ of giving a judgment. The algorithm computes “good” pⱼ's in the sense that using optimization for query assignment yields accurate and economical (cost-based) judgments for the later online queries.

In one implementation, the test set data guides the probability computation of pⱼ's as follows: given a choice of pⱼ's, a linear model may be used to measure the judgment's quality on the pair q,u, namely:

pred_{q,u}(p)=Σ_{j∈J}pⱼl(q,u,j)

The error associated with this prediction is err(q,u)=pred_{q,u}(p)−G(q,u). One approach to choosing the probabilities attempts to minimize the expected cost in some lₚ norm; (as can be readily appreciated, different answers result for different norms). For example, to minimize the l₁ norm, this can be cast as a linear programming (LP, or linear optimization) formulation as follows, with tolerance Tol>0 representing an upper threshold for the associated error, (which may be positive or negative):

minΣⱼcⱼpⱼ

Σⱼpⱼ=1

pⱼM≦sⱼ for all j∈J

err=Σ_{q,u}pred_{q,u}(p)−G(q,u) for all pairs q,u

−err≦Tol

err≦Tol

pⱼ≧0

One alternative approach is to upper bound the maximum absolute errors amongst the probabilistic judgments.

An alternative is to turn this around (as in portfolio selection) and specify a budget threshold B, and then minimize the error subject to meeting the budget. A pareto frontier is obtained by solving for different values of B or Tol. Other alternatives are feasible.

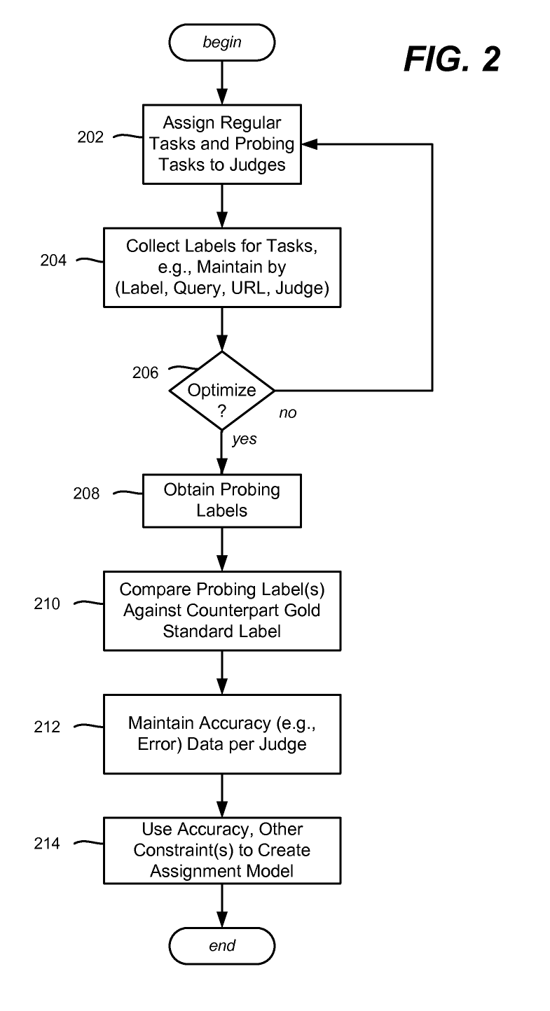

By way of summary, FIG. 2 is a flow diagram comprising example steps related to determining the distribution of tasks to judges based upon optimization as described above. Steps 202 and 204 represent assigning the regular tasks and probing tasks to the judges, and collecting and maintaining their labels, respectively. Step 206 repeats the assigning of tasks including probing tasks until an optimization point is reached. This may be based upon a number of total tasks (e.g., all) having been handled, a number of probing tasks (e.g., all) having been handled, a time deadline being reached, or any other suitable triggering mechanism.

Step 208 represents extracting the probing labels, such as if they were collected with the regular label results, whether by extracting them into a collection to be processed, or by handling them differently during the processing of the regular label results. If collected separately, for example, step 208 represents accessing the log or the like in which they were separately collected.

Step 210 compares the probing labels against the counterpart gold standard to determine the accuracy (e.g., error) data, for example. Step 212 maintains the data for each judge.

Step 214 represents using the accuracy data and other constraints to create the assignment model. Note that any of steps 208, 210, 212 and 214 may be repeated as needed, and/or combined, such as using the optimization formulation exemplified above.

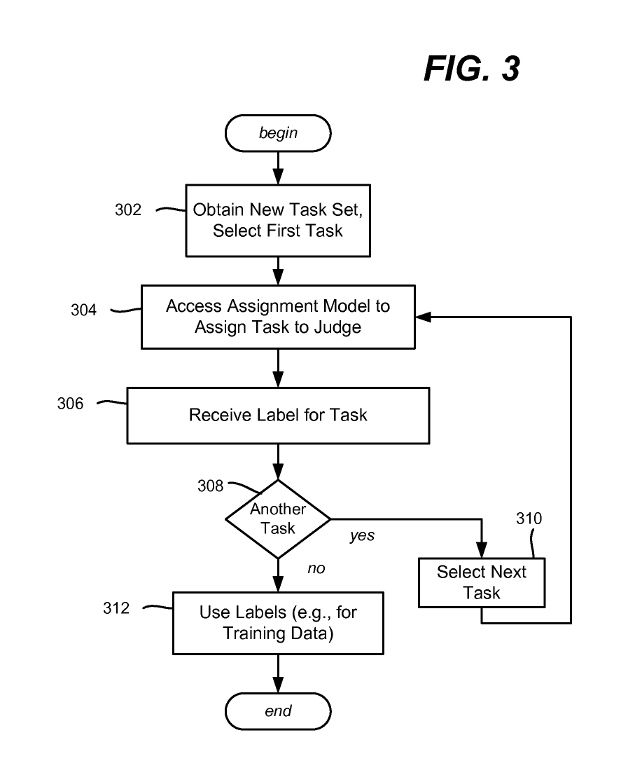

FIG. 3 shows an example of how the assignment model is used in online labeling, beginning at step 302 where a new task set has been obtained. Step 304 uses the assignment model to assign the task to a judge according to the distribution (e.g., probability) specified therein. Step 306 represents receiving the label for the task, which may be logged or the like as appropriate. Steps 308 and 310 repeat the process for the next task, until the needed tasks are completed. Step 312 then uses the labels as desired, e.g., as training data for machine learning. Note that for simplicity, FIG. 3 exemplifies the assignment model as distributing one task at a time, however as can be readily appreciated the assignment model may handle any task distribution in batches.

### Example Operating Environment

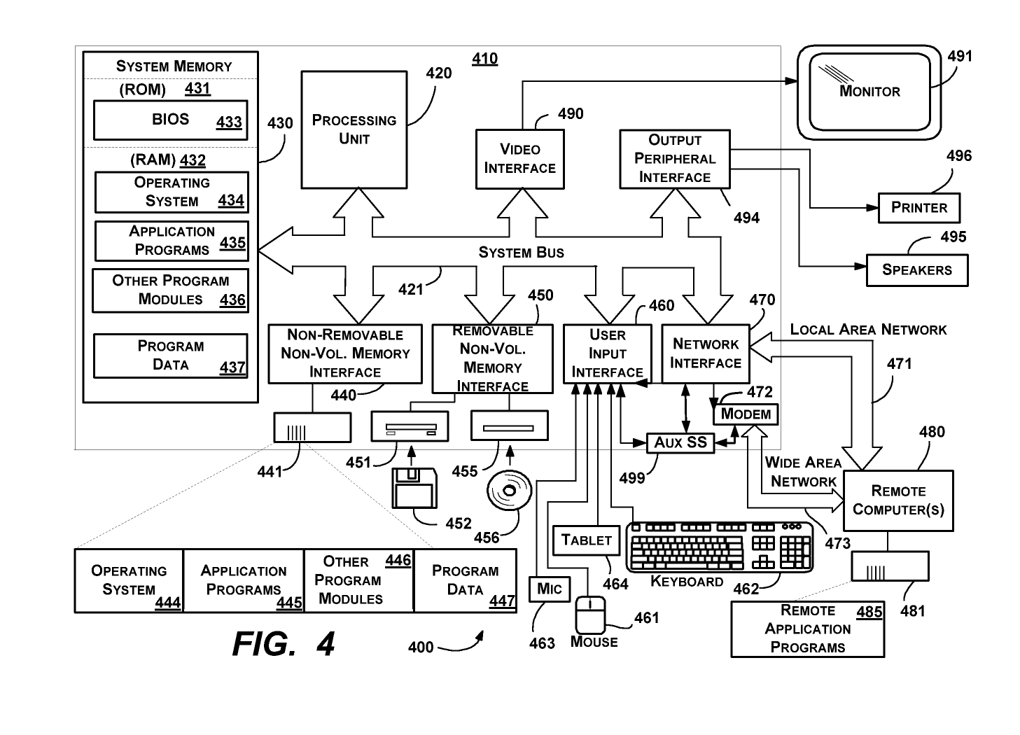

FIG. 4 illustrates an example of a suitable computing and networking environment 400 into which the examples and implementations of any of FIGS. 1-3 may be implemented. The computing system environment 400 is only one example of a suitable computing environment and is not intended to suggest any limitation as to the scope of use or functionality of the invention. Neither should the computing environment 400 be interpreted as having any dependency or requirement relating to any one or combination of components illustrated in the example operating environment 400.

The invention is operational with numerous other general purpose or special purpose computing system environments or configurations. Examples of well-known computing systems, environments, and/or configurations that may be suitable for use with the invention include, but are not limited to: personal computers, server computers, hand-held or laptop devices, tablet devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 4, an example system for implementing various aspects of the invention may include a general purpose computing device in the form of a computer 410. Components of the computer 410 may include, but are not limited to, a processing unit 420, a system memory 430, and a system bus 421 that couples various system components including the system memory to the processing unit 420. The system bus 421 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 410 typically includes a variety of computer-readable media. Computer-readable media can be any available media that can be accessed by the computer 410 and includes both volatile and nonvolatile media, and removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer 410. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above may also be included within the scope of computer-readable media.

The system memory 430 includes computer storage media in the form of volatile and/or nonvolatile memory such as read only memory (ROM) 431 and random access memory (RAM) 432. A basic input/output system 433 (BIOS), containing the basic routines that help to transfer information between elements within computer 410, such as during start-up, is typically stored in ROM 431. RAM 432 typically contains data and/or program modules that are immediately accessible to and/or presently being operated on by processing unit 420. By way of example, and not limitation, FIG. 4 illustrates operating system 434, application programs 435, other program modules 436 and program data 437.

The computer 410 may also include other removable/non-removable, volatile/nonvolatile computer storage media. By way of example only, FIG. 4 illustrates a hard disk drive 441 that reads from or writes to non-removable, nonvolatile magnetic media, a magnetic disk drive 451 that reads from or writes to a removable, nonvolatile magnetic disk 452, and an optical disk drive 455 that reads from or writes to a removable, nonvolatile optical disk 456 such as a CD ROM or other optical media. Other removable/non-removable, volatile/nonvolatile computer storage media that can be used in the example operating environment include, but are not limited to, magnetic tape cassettes, flash memory cards, digital versatile disks, digital video tape, solid state RAM, solid state ROM, and the like. The hard disk drive 441 is typically connected to the system bus 421 through a non-removable memory interface such as interface 440, and magnetic disk drive 451 and optical disk drive 455 are typically connected to the system bus 421 by a removable memory interface, such as interface 450.

The drives and their associated computer storage media, described above and illustrated in FIG. 4, provide storage of computer-readable instructions, data structures, program modules and other data for the computer 410. In FIG. 4, for example, hard disk drive 441 is illustrated as storing operating system 444, application programs 445, other program modules 446 and program data 447. Note that these components can either be the same as or different from operating system 434, application programs 435, other program modules 436, and program data 437. Operating system 444, application programs 445, other program modules 446, and program data 447 are given different numbers herein to illustrate that, at a minimum, they are different copies. A user may enter commands and information into the computer 410 through input devices such as a tablet, or electronic digitizer, 464, a microphone 463, a keyboard 462 and pointing device 461, commonly referred to as mouse, trackball or touch pad. Other input devices not shown in FIG. 4 may include a joystick, game pad, satellite dish, scanner, or the like. These and other input devices are often connected to the processing unit 420 through a user input interface 460 that is coupled to the system bus, but may be connected by other interface and bus structures, such as a parallel port, game port or a universal serial bus (USB). A monitor 491 or other type of display device is also connected to the system bus 421 via an interface, such as a video interface 490. The monitor 491 may also be integrated with a touch-screen panel or the like. Note that the monitor and/or touch screen panel can be physically coupled to a housing in which the computing device 410 is incorporated, such as in a tablet-type personal computer. In addition, computers such as the computing device 410 may also include other peripheral output devices such as speakers 495 and printer 496, which may be connected through an output peripheral interface 494 or the like.

The computer 410 may operate in a networked environment using logical connections to one or more remote computers, such as a remote computer 480. The remote computer 480 may be a personal computer, a server, a router, a network PC, a peer device or other common network node, and typically includes many or all of the elements described above relative to the computer 410, although only a memory storage device 481 has been illustrated in FIG. 4. The logical connections depicted in FIG. 4 include one or more local area networks (LAN) 471 and one or more wide area networks (WAN) 473, but may also include other networks. Such networking environments are commonplace in offices, enterprise-wide computer networks, intranets and the Internet.

When used in a LAN networking environment, the computer 410 is connected to the LAN 471 through a network interface or adapter 470. When used in a WAN networking environment, the computer 410 typically includes a modem 472 or other means for establishing communications over the WAN 473, such as the Internet. The modem 472, which may be internal or external, may be connected to the system bus 421 via the user input interface 460 or other appropriate mechanism. A wireless networking component 474 such as comprising an interface and antenna may be coupled through a suitable device such as an access point or peer computer to a WAN or LAN. In a networked environment, program modules depicted relative to the computer 410, or portions thereof, may be stored in the remote memory storage device. By way of example, and not limitation, FIG. 4 illustrates remote application programs 485 as residing on memory device 481. It may be appreciated that the network connections shown are examples and other means of establishing a communications link between the computers may be used.

An auxiliary subsystem 499 (e.g., for auxiliary display of content) may be connected via the user interface 460 to allow data such as program content, system status and event notifications to be provided to the user, even if the main portions of the computer system are in a low power state. The auxiliary subsystem 499 may be connected to the modem 472 and/or network interface 470 to allow communication between these systems while the main processing unit 420 is in a low power state.

### CONCLUSION

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. In a computing environment, a method performed at least in part on at least one processor comprising, providing probing tasks to judges to obtain accuracy-related data with respect to labeling tasks, and using the accuracy-related data to compute an assignment model for assigning other labeling tasks to at least some of the judges, in which the assignment model distributes the other labeling tasks based at least in part upon the accuracy-related data.

2. The method of claim 1 wherein using the accuracy-related data comprises performing an optimization.

3. The method of claim 1 wherein using the accuracy data comprises performing a minimization based upon error data corresponding to the accuracy-related data.

4. The method of claim 1 wherein using the accuracy-related data comprises performing an optimization based upon the accuracy data and cost data.

5. The method of claim 1 wherein using the accuracy-related data comprises performing an optimization based upon the accuracy data and quota data.

6. The method of claim 1 wherein using the accuracy-related data comprises performing an optimization based upon the accuracy data, cost data and quota data.

7. The method of claim 1 wherein providing the probing tasks to judges comprises inserting the probing tasks among regular labeling tasks assigned to the judges.

8. The method of claim 1 wherein providing probing tasks to judges to obtain the accuracy-related data comprises evaluating probing labels received from the judges that correspond to the probing tasks against gold standard labels that correspond to the probing tasks.

9. A system comprising, an assignment engine configured to provide regular tasks and probing tasks to a plurality of judges for labeling, and an optimization mechanism configured to evaluate probed labels corresponding to the probing tasks against gold standard labels to obtain accuracy-related data and optimize an assignment model based at least in part upon the accuracy-related data, in which the assignment model is useable to distribute other labeling tasks based at least in part upon the accuracy-related data to at least some of the judges.

10. The system of claim 9 wherein the optimization mechanism optimizes the assignment model based upon the accuracy-related data and at least one constraint.

11. The system of claim 9 wherein the at least one constraint comprises a quota associated with each judge.

12. The system of claim 9 wherein the at least one constraint comprises a cost associated with each judge.

13. The system of claim 9 wherein the at least one constraint comprises a quota associated with each judge.

14. The system of claim 9 wherein the at least one constraint comprises a cost associated with each judge and a quota associated with each judge.

15. The system of claim 9 wherein optimization mechanism performs an lₚ norm minimization.

16. The system of claim 9 wherein the regular tasks and probing tasks correspond to labeling query, URL pairs with a relevance score.

17. One or more computer-readable media having computer-executable instructions, which when executed perform steps, comprising:
receiving a task set comprising labeling tasks for assigning to judges; and
distributing the labeling tasks from the task set according to an assignment model, in which the assignment model is optimized at least in part according to per-judge accuracy-related data obtained by probing of the judges.

18. The one or more computer-readable media of claim 17 having further computer-executable instructions comprising, optimizing the assignment model based at least in part upon the per-judge accuracy-related data and per-judge cost data.

19. The one or more computer-readable media of claim 17 having further computer-executable instructions comprising, optimizing the assignment model based at least in part upon the per-judge accuracy-related data and per-judge quota data.

20. The one or more computer-readable media of claim 17 having further computer-executable instructions comprising, receiving labels from the judges, and using the labels in machine learning.
